(19) United States
(12) Patent Application Publication
(10) Pub. No.: US 2024/0054914 A1
(43) Pub. Date: Feb. 15, 2024

(54) SYSTEM AND METHOD FOR A SPINNING EDUCATIONAL BUILD SET

(71) Applicants: Aaron Rupp, Bountiful, UT (US); Brandon Lowe, West Jordan, UT (US); Michael J. McMahon, Sandy, UT (US)

(72) Inventors: Aaron Rupp, Bountiful, UT (US); Brandon Lowe, West Jordan, UT (US); Michael J. McMahon, Sandy, UT (US)

(21) Appl. No.: 18/448,688

(22) Filed: Aug. 11, 2023

Related U.S. Application Data
(60) Provisional application No. 63/371,200, filed on Aug. 11, 2022.

(51) Int. Cl. G09B 23/18; A63H 33/04

(52) U.S. Cl. CPC G09B 23/188; A63H 33/042; G09B 19/0053

(57) ABSTRACT

Motorized building set system with interlocked gears. A system includes a perforated panel, wherein the perforated panel comprises a plurality of holes disposed therethrough. The system includes a gear comprising a plurality of gear teeth and a central bore and an attachment device configured to releasably attach the gear to the perforated panel. The system includes a motor in mechanical communication with the gear and a safety clutch in mechanical communication with the motor.

### TECHNICAL FIELD

The disclosure relates to systems, methods, and devices for a spinning educational building set comprising a plurality of intermeshed, rotating gears.

### BACKGROUND

Toy building sets often use mechanical gears, cogs, and/or toothed wheels to transmit motion or power. Such toy building sets are often combined with a view to building model cranes, cars, machines or other devices in which axles, gears, and cogs are used to form a variety of gear functions and movement functions in the finished model.

Amusement devices are popular as children's toys. Amusement devices exist as games in United States Patent Class 273 including, but not limited to, Subclasses 239, 275, 276, 282.1, 284, 287, and 288. Other amusement devices exist; including spinning games having permanent magnets; such as those found in United States Patent Class 446, Subclass 129. In particular, US Patent Publication No. 2011/0009028, which is expressly incorporated by reference herein, uses magnetism to allow numerous magnetically coupled rotary pieces to undergo relative rotation analogous to a gear train.

A variety of spinning amusement devices exist having parts assembled for relative movement including rotary gears, pulleys, or strand-winding members such as those found in United States Patent Class 446, Subclass 112. U.S. Pat. No. 3,881,274, which is expressly incorporated by reference herein, includes square, flat base boxes configured to be coupled to each other. One base box carries a drive mechanism, and the other base boxes carry movable toys connected to the respective gears so that the several units may be coupled in various combinations and the toys of the coupled units operated simultaneously by the single driving mechanism.

While these types of devices are well received, it would still be advantageous to provide a building and educational set that would allow a user to combine gears, cogs, and/or toothed wheels of various sizes and colors and cause them to rotate to create interesting patterns. Furthermore, lights may be added to the educational set, to either shine on or through the gears, cogs, and/or toothed wheels to create interesting images and effects.

Considering the foregoing, disclosed herein are systems, methods, and devices for a building set comprising a plurality of gears and cogs that may be rotated synchronously, where the gears and cogs may be attached to panels, and optionally shining lights on or through the gears and cogs to create strobe and other effects.

### BRIEF DESCRIPTION OF THE DRAWINGS

Non-limiting and non-exhaustive implementations of the disclosure are described with reference to the following figures, wherein like reference numerals refer to like or similar parts throughout the various views unless otherwise specified. Advantages of the disclosure will become better understood regarding the following description and accompanying drawings where:

FIG. 1 is a view of an exemplary building set system of intermeshed gears and cogs disposed on perforated panels, which are mounted on a wall and a ceiling;

FIG. 2 is a close-up view of an exemplary building set system of intermeshed gears and cogs disposed on perforated panels, which are mounted on a wall;

FIG. 3 is a close-up view of an exemplary building set system of intermeshed gears and cogs disposed on perforated panels which, are mounted on a ceiling;

FIG. 4 is a close-up view of an exemplary building set system of intermeshed gears and cogs disposed on a single perforated panel;

FIGS. 5A and 5B are views of two exemplary implementations of perforated panels;

FIGS. 6A and 6B are views of the front and back sides of an attachment device;

FIG. 7 is a close-up view of an exemplary implementation of an attachment device releasably attached to an exemplary implementation of a perforated panel;

FIG. 8 is a close-up view of an exemplary implementation of a gear disposed on an exemplary implementation of a perforated panel;

FIG. 9 is a close-up view of an exemplary implementation of a motor disposed on an exemplary implementation of a perforated panel;

FIG. 10 is a view of an exemplary system of intermeshed gears and cogs disposed on perforated panels, which are mounted on a wall and a ceiling;

FIG. 11 is a perspective view of a system including a motor and a safety clutch to prevent a user from being injured during use;

FIG. 12A is a straight-on side view of a safety clutch; and

FIG. 12B is an exploded perspective side view of components of the safety clutch.

### DETAILED DESCRIPTION

Disclosed herein are systems, methods, and devices for improved building sets including gears and cogs. The building sets described herein include a motor in mechanical communication with one or more gears. The motor causes interconnected gears to rotate without additional human intervention to improve the utility and enjoyment of the building set when compared with other gear-based building sets known in the art. Additionally, the building sets described herein are constructed with improved safety features to prevent accidental pinching or catching of appendages or clothing during use.

The building sets described herein include a plurality of gears and cogs. The gears are configured to be interconnected such that the gears rotate in unison Additionally described herein are perforated panels configured to be mounted to flat surfaces such as floors, walls, ceilings, and so forth. The gears and cogs are mounted on to the perforated panels via attachment devices in such a way as to cause the teeth of each of the gears to mesh. A motor that is configured to rotate or spin at least one of the gears is also disposed on a perforated panel. To add visual interest, light may be projected onto or through the gears and cogs to enhance the effects and/or to create strobe effects. In addition, fans, lights, and/or streamers may be disposed on one or more of the gears and cogs.

Before the systems and methods for using a building set to construct systems of rotating enmeshed gears and cogs are disclosed and described, it is to be understood that this disclosure is not limited to the configurations, process steps, and materials disclosed herein as such configurations, process steps, and materials may vary. It is also to be understood that the terminology employed herein, is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise. As used herein, the term “about” used in reference to a given parameter is inclusive of the stated value and has the meaning dictated by the context (e.g., it includes the degree of error associated with measurement of the given parameter).

As used herein, the terms “comprising,” “including,” “containing,” “characterized by,” and grammatical equivalents thereof are inclusive or open-ended terms that do not exclude additional, unrecited elements or method steps.

A detailed description of systems, methods, and devices consistent with embodiments of the disclosure is provided below. While several embodiments are described, it should be understood that this disclosure is not limited to any one embodiment, but instead encompasses numerous alternatives, modifications, and equivalents. In addition, while numerous specific details are set forth in the following description to provide a thorough understanding of the embodiments disclosed herein, some embodiments may be practiced without some or all these details. Moreover, for clarity, certain technical material that is known in the related art has not been described in detail to avoid unnecessarily obscuring the disclosure.

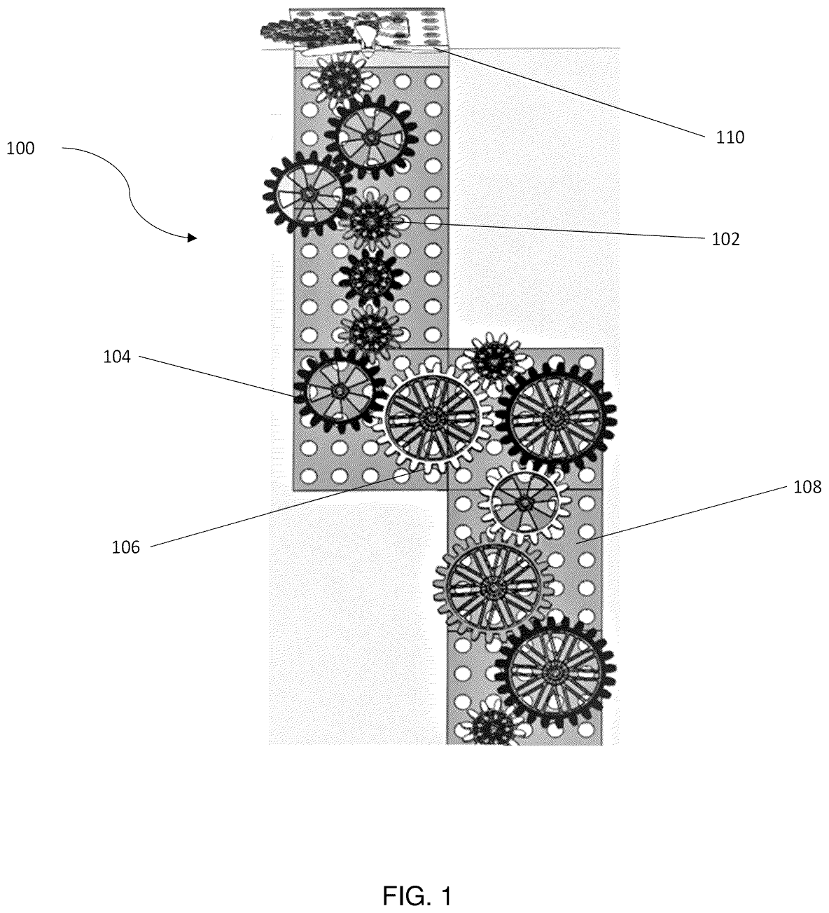

Referring now to the figures, FIG. 1 illustrates a straight-on view of a system 100 as described herein. The system 100 is configured to autonomously rotate a plurality of interconnected gears that are each attached to a perforated panel as shown in FIG. 1. The system 100 represents and improved and elegant means for preparing a gear-based arrangement that provides increased longevity and user safety.

The system 100 includes a plurality of gears 102, 104, 106. Specifically, the example illustrated in FIG. 1 includes a gear 102 with twelve teeth, a gear 104 with eighteen teeth, and a gear 106 with twenty-four teeth. It should be appreciated that the gears 102, 104, 106 may have any number of teeth depending on the implementation. However, in a typical system 100, each of the gears 102, 104, 106 is configured with a quantity of teeth that enables each gear 102, 104, 106 to engage with any other gear in the system 100. In some implementations, each of the gears 102, 104, 106 is configured with an odd or even quantity of teeth.

Each of the gears 102, 104, 106 is releasably attached to a perforated panel 108. The perforated panel 108 includes a substantially flat sheet comprising a plurality of holes disposed therethrough, as shown in FIG. 1. The holes of the perforated panel 108 may be arranged in a grid formation as shown in FIG. 1. The grid formation is optimized for disposing a plurality of the gears 102, 104, 106 through the perforated panel 108 in a way that enables the gears 102, 104, 106 to be easily interconnected with one another as shown in FIG. 1.

The system 100 includes a fan 110 attached to a gear. The fan 110 may be attached to any of the gears 102, 104, 106 irrespective of how many teeth the gear 102, 104, 106 has. The fan 110 is releasably and rigidly attached to a gear 102, 104, 106 such that the fan rotates in unison with the gear to which it is attached.

The gears 102, 104, 106 are arranged such that each individual gear (other than the first and the last gear) is adjacent to two other gears forming a gear train such that rotation of a first gear will cause a last gear in the gear train to also rotate. It is not necessary to dispose the gears in this fashion. In other implementations, a gear may be adjacent to three, four, or even more gears; only limited by size and space constraints.

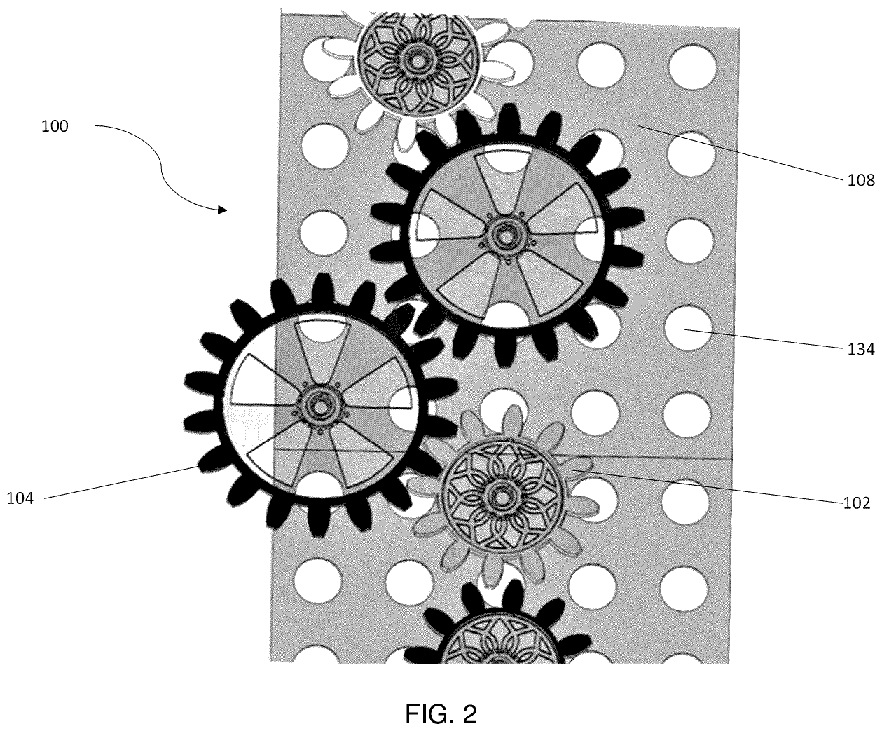

FIG. 2 is a close-up view of a portion of the system 100 first illustrated in FIG. 1. FIG. 2 provides a closer view of the holes 134 disposed through the substantially flat sheet of the perforated panel 108. The holes 134 enable are configured to receive one or more attachment devices configured for releasably securing a gear 102, 104, 106 to the perforated panel 108. It should be understood that the perforated panel 108 may be configured with any quantity of holes 134 in any suitable arrangement, depending on the implementation and the design considerations. However, in most implementations, the holes 134 will be arranged in a consistent grid-like pattern as shown in FIGS. 1 and 2.

The perforated panels 108 include a means for attaching the perforated panel 108 to a wall, ceiling, floor, or other substantially flat structure. In an embodiment, a backside of a perforated panel 108 (i.e., the side opposite the side where the gears are shown, not visible in FIGS. 1 and 2) is equipped with magnets such that the perforated panel 108 may be releasably attached to a magnetic surface. In an embodiment, the backside of the perforated panel 108 is equipped with a hook or clip such that the perforated panel 108 may be hung on a wall using a corresponding hook, screw, nail, and so forth.

The holes 134 of the perforated panel 108 enable the gears 102, 104, 106 to be securely but releasably attached to the perforated panel 108. The holes 134 may be particularly important in implementations wherein the perforated panel 108 is attached to a substantially flat and vertical surface. Particularly in this implementation, the force of the gears 102, 104, 106 may push the gears 102, 104, 106 away from one another. The holes 134 ensure that the gears remain in contact with one another.

In the exemplary implementation illustrated in FIGS. 1 and 2, the gears 102, 104, 106 are disposed on perforated panels 108 such that the teeth of the gears 102, 104, 106 mesh together even if adjacent gears are disposed on different perforated panels 108. The system 100 may include any number of perforated panels 108 as desired, and the perforated panels 108 may be disposed adjacent to each other in any suitable arrangement.

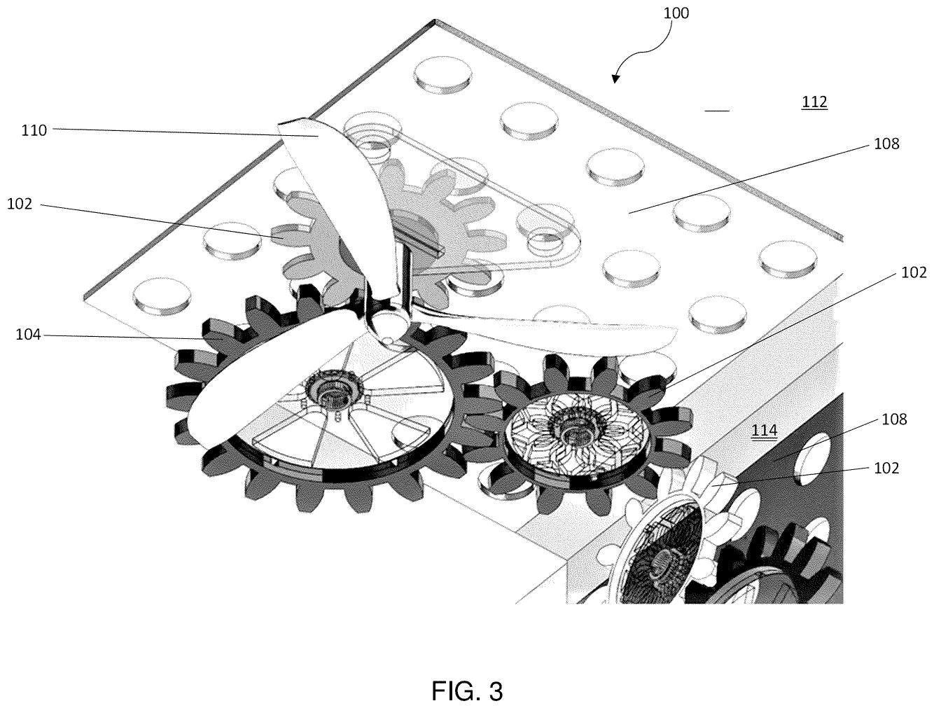

FIG. 3 is a perspective view of a portion of the system 100 first illustrated in FIG. 1. The view in FIG. 3 particularly illustrates the fan 110 that may be releasably and rigidly attached to any one of the gears 102, 104, 106. The system 100 may be equipped with other add-on objects such lights or streamers to create additional visual interest. In an embodiment, one or more of the gears 102, 104, 106 includes a magnet such that decorative metal objects may be releasably attached to the gears. The magnets may also assist in retaining and easily moving the gears on or around one or more panels.

The system may comprise a controller or microcontroller for use with communicating with and controlling the motor, gears, lights, or other portions of the building set disclosed herein. One exemplary controller or microcontroller may be an Arduino processor. Such a processor may be used as an educational tool for programming or otherwise used to control various devices in the building set.

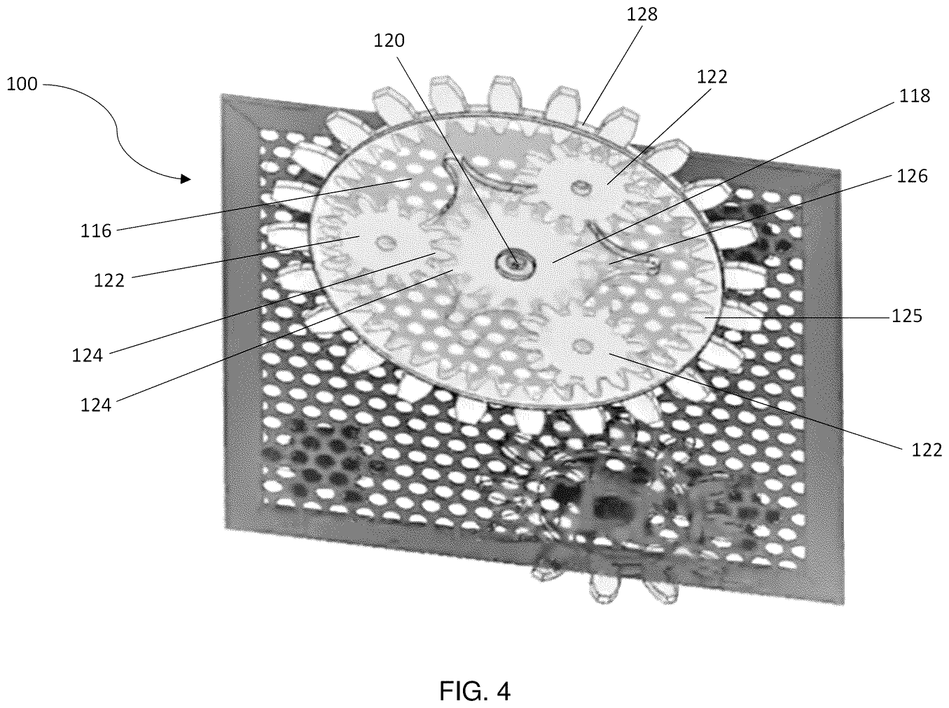

FIG. 4 is a perspective view of a portion of the system 100. In the embodiment illustrated in FIG. 4, the system 100 includes a primary gear 116. The primary gear 116 is configured to receive or support additional objects, which may specifically include additional gears as shown in FIG. 4. The primary gear 116 includes interior teeth 125 around an outer circumference 128 of primary gear 116. The primary gear 116 further comprises an attachment device 126 having six lobes, to which are attached three interior gears 122. The primary gear 116 further comprises central gear 118 disposed on an axle 120 such that teeth 124 of the center gear 118 mesh with the teeth 124 on the three additional gears 122. Thus, when the primary gear 116 is rotated in a clockwise direction, the three interior gears 122 will rotate in a counterclockwise direction and the center gear 188 will rotate in a clockwise direction. This creates a visually interesting scene in addition to the visually interesting gear train of all the other gears and cogs as they rotate.

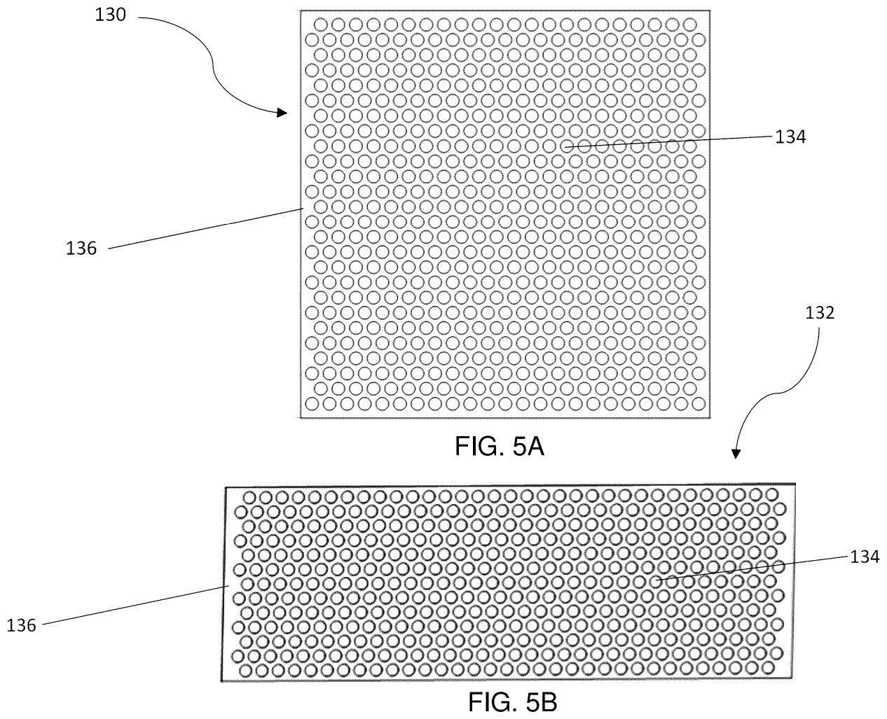

FIGS. 5A and 5B illustrate a first perforated panel 130 and a second perforated panel 132 of an exemplary implementation of a system 100. First perforated panel 130 comprises a square shape and has dimensions of 16 inches by 16 inches. First perforated panel 130 further comprises thirteen rows having twenty-two holes 134 and thirteen rows having twenty-three holes 134 for a total of 585 holes 134. Each hole 134 may have a diameter of about 0.5 inches. The spacing between holes 134 may be about 0.19 inches. Perforated panel 130 may have an edge region 136 in which there are no holes 134. The width of the edge region may be about 0.5 inches.

Second perforated panel 132 comprises a rectangle shape and has dimensions of eight inches by twenty-four inches. Second perforated panel 132 further comprises six rows having thirty-four holes 134 and seven rows having thirty-three holes 134 for a total of 435 holes 134. Each hole 134 may have a diameter of about 0.5 inches. The spacing between holes 134 may be about 0.19 inches. Perforated panel 132 may have an edge region 136 in which there are no holes 134. The width of the edge region may be about 0.5 inches.

First 130 and second 132 perforated panels, may be configured as shown in FIGS. 5A and 5B, or they may have more or fewer holes 134 in each row and/or column. Furthermore, the size of the holes 134 may be larger or smaller and the spacing between the holes 134 may be greater or less than the spacing shown in FIGS. 5A and 5B and described above.

First perforated panel 130 and second perforated panel 132 may comprise a metal, such as steel and may be attractive to magnets. First perforated panel 130 and second perforated panel 132 may comprise eighteen gage steel and may be painted various colors.

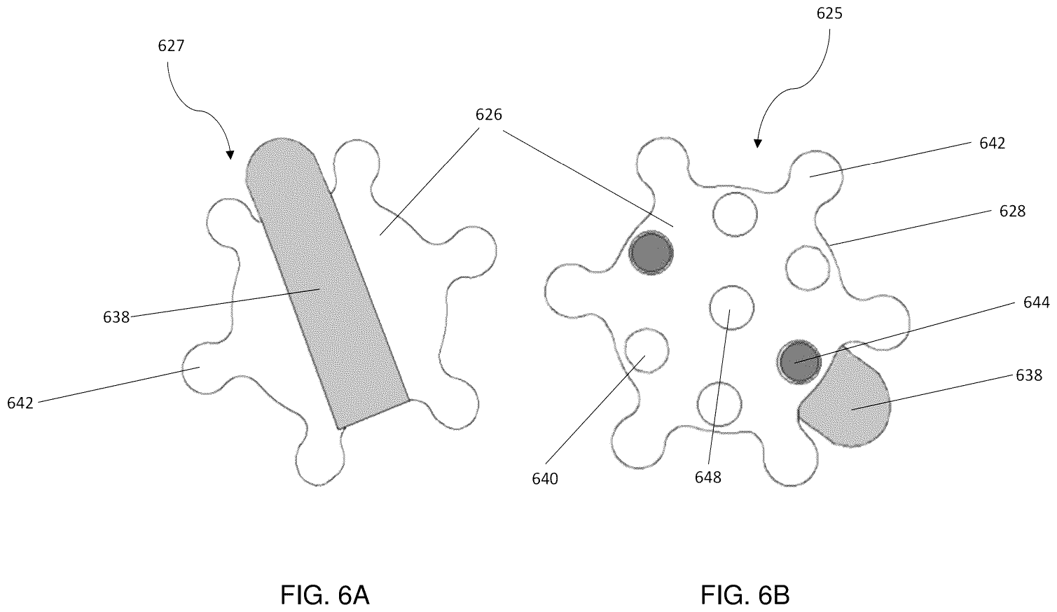

FIGS. 6A and 6B illustrate a back side 627 and a front side 625 view of an exemplary implementation of attachment device 626. Attachment device 626 comprises a disc member having a multi-lobed-shaped circumferential edge. Attachment device 626 comprises six lobes 642. The back side 627 of attachment device 626, as shown in FIG. 6A, is a planar smooth surface configured for attachment onto a gear. The back side 627 of attachment device is also configured for attachment onto a wall, ceiling, or other smooth flat surface. FIG. 6A also shows an adhesive strip 638 (shown with light shading) attached to the back side 627 of attachment device 626. Commercially available adhesive strips (that are sticky on both sides) may be used to releasably attach attachment device 626 to a gear, or to a wall, ceiling, or other smooth flat surface.

The front side 625 of attachment device 626, as shown if FIG. 6B, comprises six cylindrical holes 640 spaced around an outer circumference 628 of the disc of attachment device 626 between lobes 642. Attachment device further comprises a center post 648 configured to fit within holes 134 of perforated panels 130 and 132 (as shown in FIGS. 1-5), and to releasably and rotatably attach attachment device 626 to the perforated panels 130 and 132. FIG. 6B may also comprise two magnets 644, (shown with darker shading), disposed in two of the six cylindrical holes 640. Magnets 644 may be configured to improve the releasable attachment of attachment device 626 to perforated panels 130 and 132.

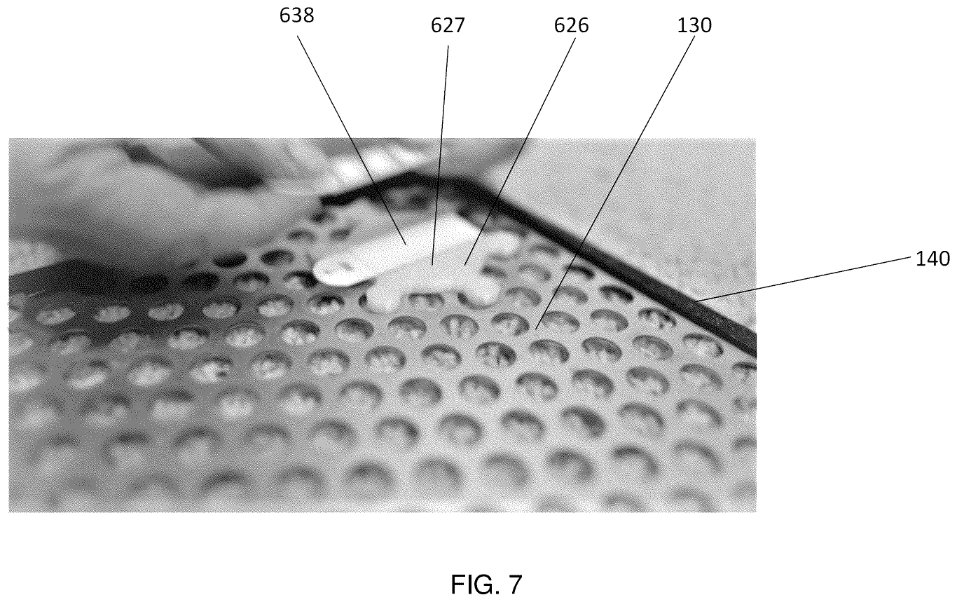

FIG. 7 illustrates an exemplary implementation in which an attachment device 626 is releasably attached to a perforated panel 130. FIG. 7 further shows adhesive strip 638 disposed on the back side 627 of attachment device 626. Attachment device 626 may be disposed on both sides of perforated panel 130. Attachment devices 626 disposed on a first side of perforated panel 130 may releasably attach panel 130 to a wall or other surface. Attachment devices 626 disposed on a second side of perforated panel 130 may releasably attach gears and/or other objects to perforated panel 130. Thus, attachment devices 626 are doubly useful, both in attaching perforated panel 130 to the wall, and in attaching gears to perforated panel 626.

FIG. 7, also illustrates a stabilizing region 140 in perforated panel 140. Stabilizing region 140 may be about 0.5 inches wide and may comprise a band of material that is folded at a 90° angle with respect to the rest of perforated panel 130. Stabilizing region 140 may be configured to provide additional stability to perforated panel 130. Perforated panel 132, as shown in FIG. 5B, may also include a stabilizing region 140.

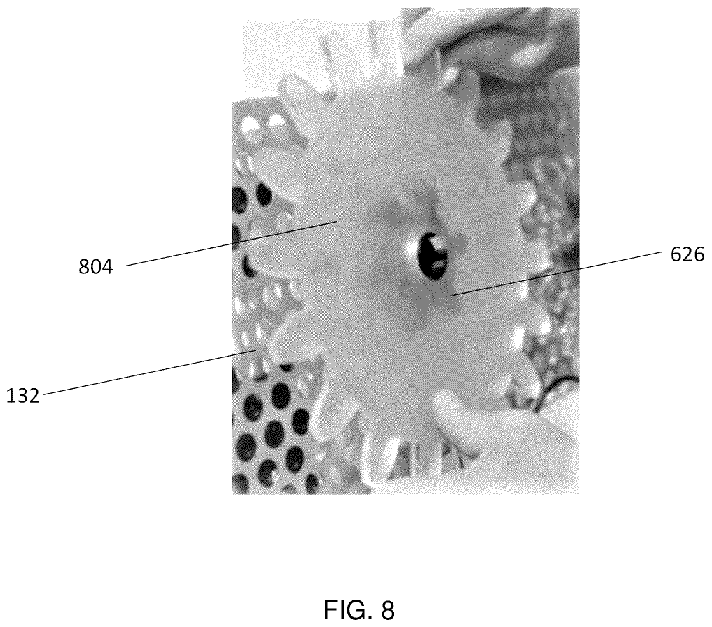

FIG. 8 illustrates an exemplary implementation in which a gear 804 is attached via attachment device 626 to perforated panel 132.

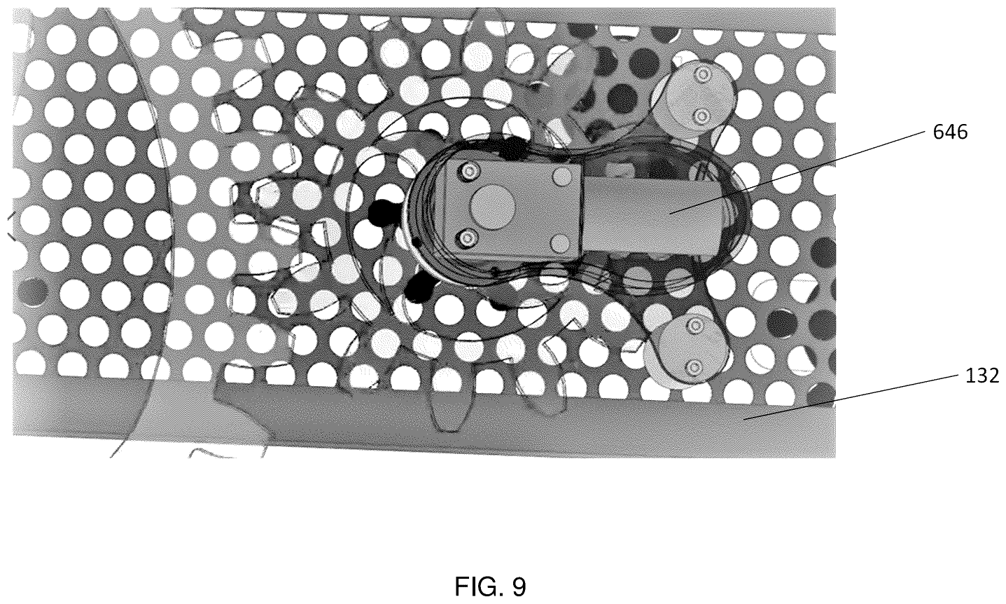

FIG. 9 illustrates an exemplary implementation in which a motor 646 is attached to perforated panel 132. As shown in FIG. 9, the motor 646 is disposed on an underside of the perforated panel 132. A gear 102, 104, 106 may be disposed on an opposite side of the perforated panel, and a shaft of an attachment device may be disposed through a central bore of the gear 102, 104, 106, through a hole of the perforated panel 132, and further into a shaft receptacle of the motor 646. This places the gear 102, 104, 106 in mechanical communication with the motor 646 and thus enables the motor 646 to cause rotation of the gear 102, 104, 106.

The combination of the motor 646 and the gears 102, 104, 106 is used to create rotational movement of the gears 102, 104, 106. The motor is an electrical or mechanical motor that converts energy (typically electrical energy) into rotational mechanical energy. The motor 646 may be powered by a battery or hardwired power source. An output shaft of the motor 646 extends from its casing and is attached to a shaft of the gear 102, 104, 106. This output shaft of the motor 646 rotates when the motor is powered. The gear 102, 104, 106 directly attached to the motor 646 is referred to as the “driving gear.” The driving gear is attached to the motor's 646 output shaft and receives its rotational motion. The driving gear is interlocked with another gear, which may be referred to as the “driven gear.” The driven gear is positioned on a separate shaft, and its rotation is controlled by the motion of the driving gear.

The combination of gears 102, 104, 106 allows a user to create a mechanical advantage. For example, if the driving gear is smaller than the driven gear, the driven gear will rotate more slowly than the driving gear but with increased torque. Conversely, if the driving gear is larger, the driven gear will rotate faster but with reduced torque. Depending on the arrangement of gears and their teeth, the rotation of the driven gear can be in the same direction as the driving gear or in the opposite direction.

The motor 646 provides the initial rotational force, and then the plurality of gears 102, 104, 106 attached to the perforated panel 132 will transmit and manipulate that motion to achieve specific speed, torque, and direction requirements for the application. The use of gears 102, 104, 106 allows for various forms of motion control and energy transformation in the system 100.

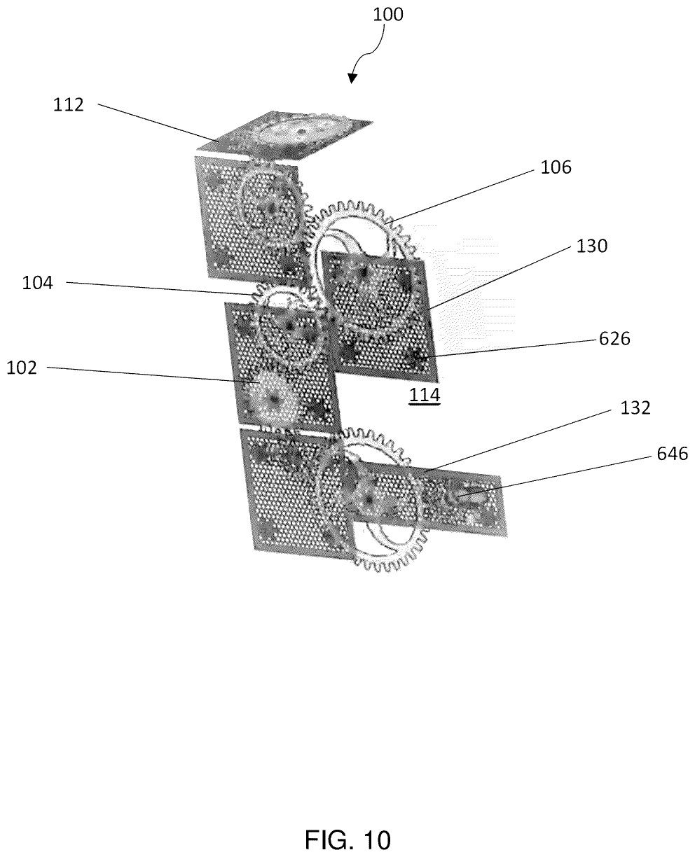

FIG. 10 shows an exemplary implementation of a system 100 in which gears 102, 104, and 106 are releasably attached to perforated panels 130 and 132. Note that perforated panels 130 are square and perforated panel 132 is rectangular. FIG. 10 further shows that perforated panels 130 and 132 are releasably attached to a wall 114 and a ceiling 112. As discussed previously, the gears 102, 104, and 106 may comprise many different sizes and the number of teeth on the gears 102, 104, and 106 may vary from as low as six to as many as thirty-six, or even more. The gears 102, 104, and 106 may be solid gears or they may be configured as a hub and spokes design. Additionally, the gears 102, 104, and 106 may comprise a solid-colored plastic or may comprise a clear plastic.

FIG. 10 also illustrates attachment devices 626, releasably attached in each corner of each of the perforated panels 130 and 132. FIG. 10 further shows motor 646 disposed on perforated panel 132.

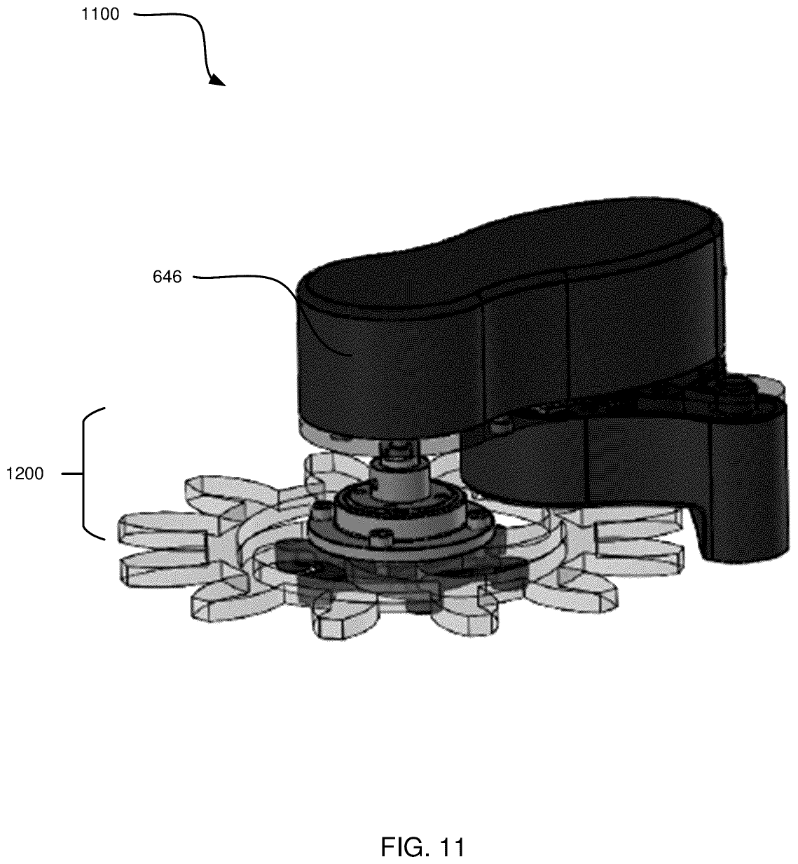

FIG. 11 is a perspective view of a system 1100 for integrating a safety clutch 1200 with the motor 646. The safety clutch 1200 is in mechanical communication with the motor 646 and prevents a user from being injured by the motor 646 or any of the gears 102, 104, 106 being rotated by the motor 646. Specifically, the safety clutch 1200 is designed to prevent a small child from being injured by the gears 102, 104, 106 after sticking a finger, object, or other device into the gears 102, 104, 106.

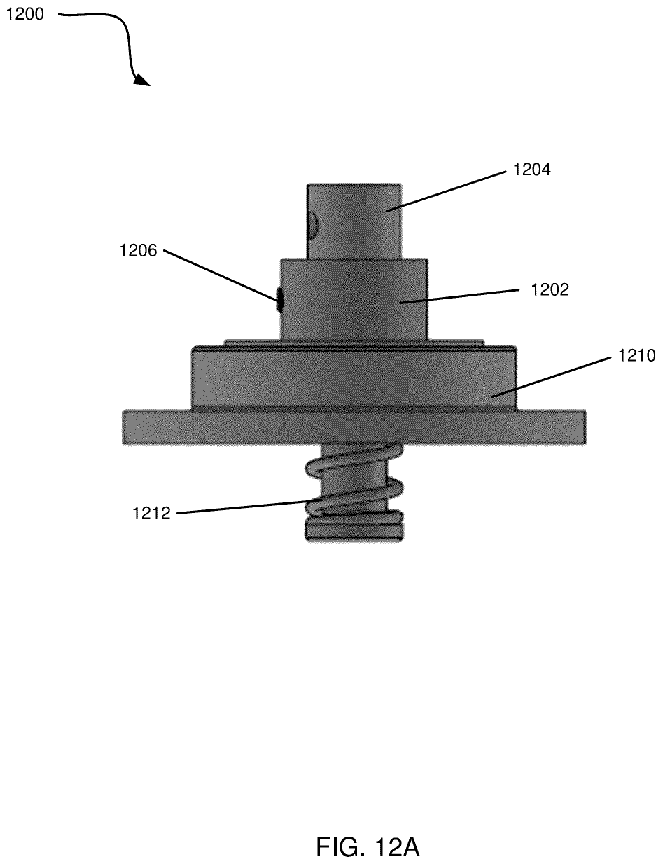

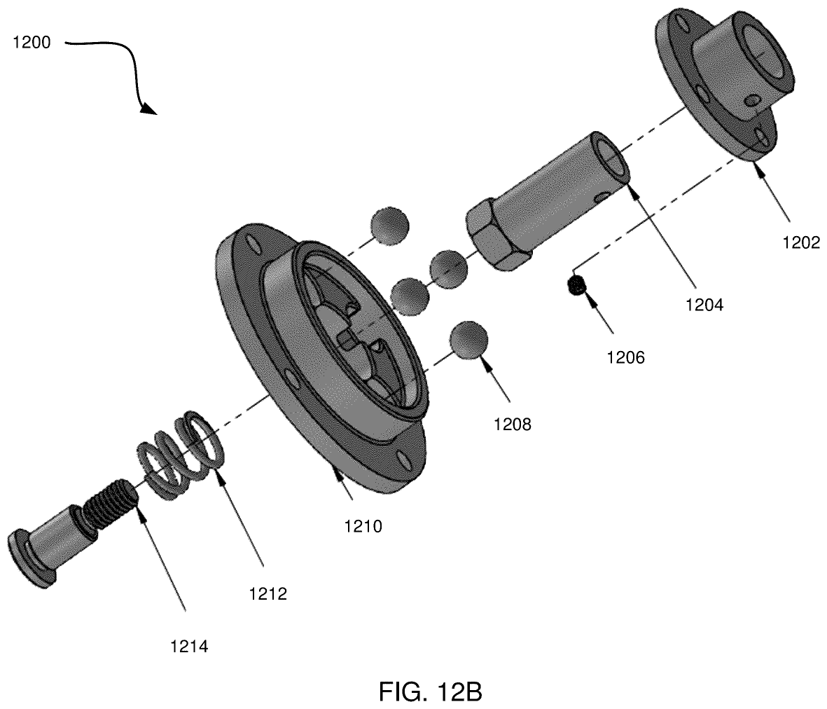

FIGS. 12A and 12B illustrate the safety clutch 1200 to be used in connection with the motor 646 of the system 100. FIG. 12A is a straight-on side view of the safety clutch 1200 and FIG. 12B is an exploded perspective side view of components of the safety clutch 1200.

The safety clutch 1200 includes a motor coupling flange 1202, a shaft coupler 1204, one or more fasteners 1206 such as a screw, one or more ball bearings 1208, a safety clutch housing 1210, a compression spring 1212, and a shoulder fastener 1214 which may specifically include a screw.

The shaft coupler 1204 is configured to be disposed within a corresponding shaft receptacle of the motor 646. The shaft coupler 1204 thereby places the safety clutch 1200 in rotational and mechanical communication with the motor 646. The motor coupling flange 1202 includes holes disposed therethrough (as shown in FIG. 12B) that enable the motor coupling flange 1202 to be fastened to a portion of the motor 646.

The safety clutch 1200 is configured to protect the motor 646 from damage caused by overload or sudden shock loads. The safety clutch 1200 mechanism incorporates the ball bearings 1208 to provide smooth and controlled disengagement from the motor 646 when excessive force or torque is applied. In the system 100, excessive force may be applied when the motor 646 is engaged and one of the gears 102, 104, 106 is held stationary against the rotational force of the motor 646, when one of the gears 102, 104, 106 is caught, when one of the gears 102, 104, 106 is rotated in a direction opposite the rotational direction of the motor 646, and so forth.

The one or more ball bearings 1208 are disposed within a center portion of the safety clutch housing 1210. The one or more ball bearings 1208 receive tension from the compression spring 1212. When the force on the safety clutch 1200 exceeds a tolerance threshold (e.g., from a user placing a finger inside a spinning gear), then the one or more ball bearings 1208 will cause the gears to disengage until the obstruction is removed or the system is powered down.

During regular operation, the safety clutch 1200 allows the motor 646 to operate smoothly and transmit power from its driving component to the gears 102, 104, 106. The ball bearings 1208 are engaged and provide a direct connection between the motor 646 and the driven components (i.e., the gears 102, 104, 106).

If an overload or shock load occurs in the machinery, such as a sudden increase in force or torque beyond a threshold design limit, the safety clutch 1200 is then engaged. This sudden increase in force or torque may occur when, for example, a user places a finger inside a gear or between gears, a user stops a gear from rotating, a user forces a gear to rotate in a direction opposite the rotation caused by the motor 646, and so forth.

The ball bearings 1208 in the safety clutch 1200 slip or disengage in response to experiencing the force or torque above the threshold limits. This slipping action prevents the excessive load from being directly transmitted to the driven component. By slipping or disengaging, the safety clutch 1200 absorbs and dissipates the excess force and thus protects both the motor 646 and the user. This action prevents damage to the equipment and helps prevent accidents or injuries caused by sudden overloads.

After the overload situation is resolved or the shock load is eliminated, the safety clutch 1200 resets manually or automatically. Once reset, the safety clutch 1200 is ready to resume normal operation. The safety clutch 1200 provides an extra layer of protection against unexpected load conditions, and thus extends the lifespan of the motor 646 and ensures the safety of users of the system 100. Additionally, the ball bearings 1208 of the safety clutch 1200 contribute to smoother disengagement of the motor 646 from the gears 102, 104, 106 during overload situations.

A method of creating a building set for rotating gears and cogs disposed on perforated panels is disclosed. The method includes disposing attachment devices on a smooth flat surface. The method continues and perforated panels are disposed on the attachment devices. The method continues and attachment devices are attached to the gears and cogs. The method continues and the gears and cogs are disposed onto the perforated panels via the attachment devices. The method continues and a motor, configured to rotate at least one of the gears is disposed onto one of the perforated panels. The method continues and a controller or microcontroller may be in communication with and actuate a motor and/or lights associated with the building set.

### EXAMPLES

The following examples pertain to further embodiments.

Example 1 is a building set comprising: gears, attachment devices, and perforated panels; wherein the gears are mounted on the attachment devices and disposed on the perforated panels.

Example 2 is a building set as in Example 1, further comprising a motor configured to rotate at least one of the gears.

Example 3 is a building set as in any of Examples 1-2, wherein the attachment devices comprise a disc member having a multi-lobed-shaped circumferential edge.

Example 4 is a building set as in any of Examples 1-3, wherein the disc member has six lobes.

Example 5 is a building set as in any of Examples 1-4, wherein a first side of the disc member includes one or more magnets configured to releasably attach to a perforated panel.

Example 6 is a building set as in any of Examples 1-5, wherein the perforated panels comprise a metal.

Example 7 is a building set as in any of Examples 1-6, wherein the perforated panels comprise eighteen gage steel.

Example 8 is a building set as in any of Examples 1-7, wherein a first side of the disc member is configured to be releasably attached to a perforated panel and a second of the disc member is configured to be releasably attached to a gear.

Example 9 is a building set as in any of Examples 1-8, wherein a first side of the disc member is configured to be releasably attached to a perforated panel and a second of the disc member is configured to be releasably attached to a smooth flat surface.

Example 10 is a building set as in any of Examples 1-9, wherein the gears comprise a plastic material.

Example 11 is a building set as in any of Examples 1-10, wherein the gears comprise a clear see-through plastic.

Example 12 is a building set as in any of Examples 1-11, wherein the gears comprise a see-through plastic that is colored.

Example 13 is a building set as in any of Examples 1-12, wherein the gears comprise external teeth.

Example 14 is a building set as in any of Examples 1-13, wherein at least one of the gears further comprises internal teeth.

Example 15 is a building set as in any of Examples 1-14, wherein at least one of the gears comprise one or more internal gears.

Example 16 is a building set as in any of Examples 1-15, further comprising lights shining onto and/or through the gears.

Example 17 is a building set as in any of Examples 1-16, further comprising at least one object disposed on an exterior surface of at least one of the gears.

Example 18 is a building set as in any of Examples 1-17, wherein the at least one object disposed on an exterior surface of at least one of the gears is a fan.

Example 19 is a building set as in any of Examples 1-18, wherein the at least one object disposed on an exterior surface of at least one of the gears is a light.

Example 20 is a building set as in any of Examples 1-19, wherein the at least one object disposed on an exterior surface of at least one of the gears is a streamer.

Example 21 is a building set as in any of Examples 1-20, wherein at least one of the perforated panels has thirteen rows of holes having twenty-two holes in each row and thirteen rows of holes having twenty-three holes for a total of twenty-six rows and 585 holes.

Example 22 is a building set as in any of Examples 1-21, wherein at least one of the perforated panels has six rows of holes having thirty-four holes in each row and seven rows of holes having thirty-three holes for a total of thirteen rows and 435 holes.

Example 23 is a building set as in any of Examples 1-22, wherein at least one of the perforated panels has dimensions of sixteen inches by sixteen inches.

Example 24 is a building set as in any of Examples 1-23, wherein at least one of the perforated panels has dimensions of eight inches by twenty-four inches.

Example 25 is a building set as in any of Examples 1-24, wherein at least one perforated panel hangs from a horizontal surface such as a ceiling.

Example 26 is a system of rotating gears disposed on perforated panels. The system includes a controller or microcontroller that is in communication with and actuates a motor and/or lights associated with a building set.

Example 27 is a system of rotating gears disposed on perforated panels. The system includes gears, attachment devices, and perforated panels; wherein the gears are mounted on the attachment devices and disposed on the perforated panels. The system includes any of the features described in connection with the building set of Examples 1-26.

Example 28 is a system as in any of Examples 1-27, further comprising a safety clutch.

Example 29 is a system as in any of Examples 1-28, wherein the safety clutch comprises a plurality of ball bearings.

Example 30 is a system as in any of Examples 1-29, wherein the safety clutch comprises a compression spring.

Example 31 is a system as in any of Examples 1-30, wherein the safety clutch is in mechanical communication with the motor and is configured to cause one or more gears to disengage when a threshold amount of pressure is applied to the compression spring.

Example 32 is a method of creating a system for rotating gears disposed on perforated panels. The method includes disposing attachment devices on a smooth flat surface. The method continues and perforated panels are disposed on the attachment devices. The method continues and attachment devices are attached to gears. The method continues and the gears are disposed onto the perforated panels via the attachment devices. The method continues and a motor, configured to rotate at least one of the gears is disposed onto one of the perforated panels. The method continues and a controller or microcontroller may be in communication with and actuate a motor and/or lights associated with the building set. The method includes any of the features described in connection with the device of Examples 1-31.

Example 33 is a system. The system includes a perforated panel, wherein the perforated panel comprises a plurality of holes disposed therethrough. The system includes a gear comprising a plurality of gear teeth and a central bore. The system includes an attachment device configured to releasably attach the gear to the perforated panel, wherein the attachment device is configured to be disposed through the central bore of the gear and one of the plurality of holes of the perforated panel. The system includes a motor in mechanical communication with the gear. The system includes a safety clutch in mechanical communication with the motor.

Example 34 is a system as in Example 33, wherein the safety clutch is configured to disengage the motor from the gear in response to experiencing a force or torque that exceeds a threshold.

Example 35 is a system as in any of Examples 33-34, wherein the safety clutch comprises ball bearings configured to provide controlled disengagement of the motor from the gear in response to the safety clutch receiving a force or torque that exceeds a threshold.

Example 36 is a system as in any of Examples 33-35, wherein the safety clutch comprises: a plurality of ball bearings; and a compression spring, wherein the plurality of ball bearings receive tension from the compression spring in response to the compression spring being depressed.

Example 37 is a system as in any of Examples 33-36, wherein the plurality of holes of the perforated panel are organized in a grid pattern, and wherein a spacing between the plurality of holes is optimized based at least in part on a size of the gear.

Example 38 is a system as in any of Examples 33-37, wherein the system comprises a plurality of gears, and wherein two or more of the plurality of gears comprises a different quantity of teeth.

Example 39 is a system as in any of Examples 33-38, wherein the gear is attached to the perforated panel by way of the attachment device such that the gear is prevented from translatory motion and is allowed to rotate about an axis of rotation of the gear defined through the central bore.

Example 40 is a system as in any of Examples 33-39, wherein the system comprises a plurality of gears each comprising a plurality of teeth, and wherein the plurality of gears are configured to interlock with one another such that rotation of one of the plurality of gears will cause rotation of all remaining gears of the plurality of gears.

Example 41 is a system as in any of Examples 33-40, wherein the motor causes the gear to rotate about an axis of rotation of the gear, wherein the axis of rotation of the gear is defined through the central bore.

Example 42 is a system as in any of Examples 33-41, further comprising a magnet attached to the perforated panel.

Example 43 is a system as in any of Examples 33-42, wherein the gear is constructed of a rigid polycarbonate material.

Example 44 is a system as in any of Examples 33-43, wherein the attachment device configured to releasably attach the gear to the perforated panel comprises: a bolt comprising a shaft configured to be disposed through the central bore of the gear and one of the plurality of holes of the perforated panel; and a nut configured to screw on to the bolt and attach the gear to the perforated panel.

Example 45 is a system as in any of Examples 33-44, wherein the bolt is disposed through the central bore of the gear, and wherein the central bore of the gear defines an axis of rotation of the gear, and wherein the gear is permitted to rotate about the axis of rotation when the gear is attached to the perforated panel.

Example 46 is a system as in any of Examples 33-45, wherein the gear is a driving gear in direct mechanical communication with an output shaft of the motor; and wherein the system further comprises a driven gear in mechanical communication with the driving gear such that rotation of the driving gear causes rotation of the driven gear.

Example 47 is a system as in any of Examples 33-46, wherein the perforated panel is constructed of a rigid polycarbonate material.

Example 48 is a system as in any of Examples 33-47, further comprising a battery in electrical communication with the motor.

Example 49 is a system as in any of Examples 33-48, wherein the attachment device comprises: an output shaft of the motor, wherein the output shaft is disposed through the one of the plurality of holes of the perforated panel and further disposed through the central bore of the gear; and a nut configured to screw on to the output shaft of the motor to releasably secure the gear to the perforated panel and the motor; wherein the motor causes the output shaft to rotate, and wherein rotation of the output shaft causes rotation of the gear.

Example 50 is a system as in any of Examples 33-49, wherein the central bore of the gear comprises one or more of a quadrilateral or hexagonal geometry, and wherein the output shaft of the motor comprises a corresponding cross-sectional geometry such that rotation of the output shaft causes rotation of the gear.

Example 51 is a system as in any of Examples 33-50, further comprising a fan attached to the gear, wherein rotation of the motor causes rotation of the gear and the fan.

Example 52 is a system as in any of Examples 33-51, further comprising a light attached to the gear.

Reference throughout this specification to “an example” means that a particular feature, structure, or characteristic described in connection with the example is included in at least one embodiment of the disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the disclosure may be referred to herein along with alternatives for the various components thereof. It is understood that such embodiments, examples, and alternatives are not to be construed as de facto equivalents of one another but are to be considered as separate and autonomous representations of the disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure.

What is claimed is:

1. A system comprising:
a perforated panel, wherein the perforated panel comprises a plurality of holes disposed therethrough;
a gear comprising a plurality of gear teeth and a central bore;
an attachment device configured to releasably attach the gear to the perforated panel, wherein the attachment device is configured to be disposed through the central bore of the gear and one of the plurality of holes of the perforated panel;
a motor in mechanical communication with the gear; and
a safety clutch in mechanical communication with the motor.

2. The system of claim 1, wherein the safety clutch is configured to disengage the motor from the gear in response to experiencing a force or torque that exceeds a threshold.

3. The system of claim 1, wherein the safety clutch comprises ball bearings configured to provide controlled disengagement of the motor from the gear in response to the safety clutch receiving a force or torque that exceeds a threshold.

4. The system of claim 1, wherein the safety clutch comprises:
a plurality of ball bearings; and
a compression spring, wherein the plurality of ball bearings receive tension from the compression spring in response to the compression spring being depressed.

5. The system of claim 1, wherein the plurality of holes of the perforated panel are organized in a grid pattern, and wherein a spacing between the plurality of holes is optimized based at least in part on a size of the gear.

6. The system of claim 1, wherein the system comprises a plurality of gears, and wherein two or more of the plurality of gears comprises a different quantity of teeth.

7. The system of claim 1, wherein the gear is attached to the perforated panel by way of the attachment device such that the gear is prevented from translatory motion and is allowed to rotate about an axis of rotation of the gear defined through the central bore.

8. The system of claim 1, wherein the system comprises a plurality of gears each comprising a plurality of teeth, and wherein the plurality of gears are configured to interlock with one another such that rotation of one of the plurality of gears will cause rotation of all remaining gears of the plurality of gears.

9. The system of claim 1, wherein the motor causes the gear to rotate about an axis of rotation of the gear, wherein the axis of rotation of the gear is defined through the central bore.

10. The system of claim 1, further comprising a magnet attached to the perforated panel.

11. The system of claim 1, wherein the gear is constructed of a rigid polycarbonate material.

12. The system of claim 1, wherein the attachment device configured to releasably attach the gear to the perforated panel comprises:
a bolt comprising a shaft configured to be disposed through the central bore of the gear and one of the plurality of holes of the perforated panel; and
a nut configured to screw on to the bolt and attach the gear to the perforated panel.

13. The system of claim 12, wherein the bolt is disposed through the central bore of the gear, and wherein the central bore of the gear defines an axis of rotation of the gear, and wherein the gear is permitted to rotate about the axis of rotation when the gear is attached to the perforated panel.

14. The system of claim 1, wherein the gear is a driving gear in direct mechanical communication with an output shaft of the motor; and
wherein the system further comprises a driven gear in mechanical communication with the driving gear such that rotation of the driving gear causes rotation of the driven gear.

15. The system of claim 1, wherein the perforated panel is constructed of a rigid polycarbonate material.

16. The system of claim 1, further comprising a battery in electrical communication with the motor.

17. The system of claim 1, wherein the attachment device comprises:
an output shaft of the motor, wherein the output shaft is disposed through the one of the plurality of holes of the perforated panel and further disposed through the central bore of the gear; and
a nut configured to screw on to the output shaft of the motor to releasably secure the gear to the perforated panel and the motor;
wherein the motor causes the output shaft to rotate, and wherein rotation of the output shaft causes rotation of the gear.

18. The system of claim 17, wherein the central bore of the gear comprises one or more of a quadrilateral or hexagonal geometry, and wherein the output shaft of the motor comprises a corresponding cross-sectional geometry such that rotation of the output shaft causes rotation of the gear.

19. The system of claim 1, further comprising a fan attached to the gear, wherein rotation of the motor causes rotation of the gear and the fan.

20. The system of claim 1, further comprising a light attached to the gear.
